(19) United States
(12) Patent Application Publication
(10) Pub. No.: US 2018/0029294 A1
(43) Pub. Date: Feb. 1, 2018

(54) POWDER CHAMBER TABLE ASSEMBLY

(71) Applicant: CL SCHUTZRECHTSVERWALTUNGS GMBH, Lichtenfels (DE)

(72) Inventors: Frank HERZOG, Lichtenfels (DE); Frank Schödel, Kronach (DE); Florian Bechmann, Lichtenfels (DE)

(73) Assignee: CL SCHUTZRECHTSVERWALTUNGS GMBH, Lichtenfels (DE)

(21) Appl. No.: 15/663,473

(22) Filed: Jul. 28, 2017

(30) Foreign Application Priority Data
Jul. 29, 2016 (DE) 102016114054.6

(51) Int. Cl. B29C 64/153; B33Y 30/00; B22F 3/105; B29C 64/245; B29C 64/259

(52) U.S. Cl. CPC B29C 64/153; B29C 64/245; B29C 64/259; B22F 3/1055; B33Y 30/00; B23K 26/34

(57) ABSTRACT

The invention relates to a powder chamber table assembly (1) for a powder module, especially a construction module, of an apparatus for additive manufacturing of three-dimensional objects, comprising at least two components or component groups to be sealed to each other especially in terms of the intrusion of powdered construction material, wherein the at least two components or component groups are sealed to each other by at least one sealing element (9), wherein the sealing element (9) is formed of or comprises a high temperature resistant silicone material.

The invention relates to a powder chamber table assembly for a powder module, especially a construction module, of an apparatus for additive manufacturing of three-dimensional objects, comprising at least two components or component groups to be sealed, especially in terms of the intrusion of powdered construction material, wherein the at least two components or component groups are sealed to each other by at least one sealing element.

Powder chamber table assemblies are actually known as functional components of powder modules, typically comprising a powder room for receiving or dispensing powdered construction material. The structural design of appropriate powder chamber table assemblies provides for several different functionalized components or component groups, wherein at least two components or component groups are typically to be sealed to each other in terms of the intrusion of powdered construction material. In order to prevent the powdered construction material from intruding between the components or component groups, it is common to seal respective components or component groups to each other by a sealing element.

Sealing elements used so far could be improved in terms of their structural properties regarding their sealing effect and sealing potential, since, for example, they have a comparatively low thermal stability or a comparatively low elasticity or flexibility.

The invention is based on the object of providing, in contrast to the above, especially in terms of sealing effect and sealing potential, an improved powder chamber table assembly.

The object is solved by a powder chamber table assembly according to claim 1. The dependent claims relate to possible embodiments of the powder chamber table assembly.

The powder chamber table assembly described herein is a functional component of a powder module, i.e. especially a construction module, in which the actual additive construction of three-dimensional objects is done when performing additive manufacturing processes. The powder module in turn represents a functional component of an apparatus for additive manufacturing of three-dimensional objects. The apparatus can e.g. be an apparatus for performing selective laser melting processes, i.e. an SLM apparatus, or an apparatus for performing selective laser sintering processes, i.e. an SLS apparatus.

The powder chamber table assembly comprises at least two components or component groups that are to be sealed to each other especially in terms of the intrusion of powdered construction material. A component group is understood as an assembly of components functionally belonging to each other, and especially connected with each other. Hereinafter, the short term “components” is used; the term “component” also includes component groups. In order to seal the at least two components, the powder chamber table assembly comprises at least one sealing element, which seals the at least two components to be sealed to each other in the assembly state of the powder chamber table assembly. In order to seal the at least two components to each other, the sealing element is arranged or formed at least partially between the at least two components.

The sealing element is formed of or comprises a one-component or multicomponent high temperature resistant silicone material or silicone. Hereinafter, the short term “silicone material” is used. By forming the sealing element of a respective silicone material or—in case the sealing element comprises a high temperature resistant silicone material—the addition of a high temperature resistant silicone material to another sealing element material, the sealing element is downright high temperature resistant. The sealing properties of the sealing element are thus also given at comparatively high temperatures, as may affect the sealing element especially when forming the powder chamber table assembly for a heatable construction module. Depending on the precise chemo-physical structure, the silicone material and thus the sealing element can have a temperature resistance of up to a temperature range of at least 200° C., especially above 250° C., possibly at least temporarily above 300° C. The term “temperature resistance” is understood to mean that the silicone material experiences no (significant) change of the structural properties, especially the sealing properties, at the respective temperature.

However, the silicone material is not only characterized by its specific temperature resistance, but also by its elasticity or flexibility, especially at appropriately high temperatures. The elasticity or flexibility of the silicone material especially also given, as mentioned, at appropriately high temperatures ensures that the sealing element, e.g. due to a thermal-related embrittlement, is not damaged, e.g. related to breaking or tearing, which would affect its sealing properties.

Overall, especially in terms of sealing effect and sealing potential, an improved powder chamber table assembly is provided.

The silicone material can, for example, be acetate silicone or silicone rubber (VMQ) or silicone elastomer. Acetate silicones as well as silicone rubbers or silicone elastomers typically have a comparatively high thermal stability and thus a high temperature resistance. Furthermore, acetate silicones have excellent adhesive properties that guarantee a simple and non-detachable assembly of the sealing element.

Furthermore, the silicone material can be at least partially cross-linked. The cross-linking of the silicone material realized e.g. by means of highly (energetic) radiation typically further improves the thermal stability and thus the temperature resistance thereof.

Further, examples are given for components to be sealed to each other by means of the sealing element or sealed to each other in the assembly state of the powder chamber table assembly; as mentioned, the sealing element is always arranged or formed at least partially between the respective components.

The powder chamber table assembly can comprise an, especially plate-type or plate-shaped, insulating body and an, especially plate-type or plate-shaped, supporting body arranged or formed below the insulating body. In this case, the sealing element can be arranged or formed at least partially between the insulating body and the supporting body. The sealing element seals the insulating body to the supporting body (or vice versa) such that an intrusion of powdered construction material into the sealing section defined hereby is not possible. The sealing element can be arranged or formed in a groove-type or groove-shaped sealing element receiving section formed in an insulating body, especially in a surface section of the insulating body facing the supporting body. The sealing element can be arranged or formed in the sealing element receiving section, at least partially, possibly completely, filling in the groove-shaped sealing element receiving section. The sealing element receiving section can be formed at least partially undercut to ensure a stable, non-detachable arrangement of the sealing element therein.

The powder chamber table assembly can further comprise an, especially plate-type or plate-shaped, heater comprising a heating element formed as or comprising a heating coil, forming an exposed top face of the powder chamber table assembly, and the one (already mentioned) or an, especially plate-type or plate-shaped, insulating body arranged or formed below said heater. In this case, the sealing element can be arranged or formed at least partially between the heater and the insulating body. The sealing element seals the heater to the insulating body (or vice versa) such that an intrusion of powdered construction material into the sealing section defined hereby is not possible. The sealing element can be arranged or formed in a joint-type sealing element receiving section that is open on one side and extends between the heater and the insulating body. The joint-type sealing element receiving section can be formed by a recess or clearance in the heater and/or the insulating body. The sealing element can be arranged or formed in the joint gap at least partially filling in the joint-type sealing element receiving section. Here, the sealing element receiving section can also be formed at least partially undercut to ensure a stable, non-detachable arrangement of the sealing element therein.

It applies to all embodiments that the sealing element can be provided with any, possibly varying, cross-section geometries or profiles. The cross-section geometry of the sealing element is selected especially depending on the geometric structural design of the sealing element receiving section receiving the sealing element. Cross-section geometries open on one side, i.e. U-type or C-type, for example, are mentioned merely exemplary.

If required, separate fastening elements can be provided for fastening the sealing element in a respective sealing element receiving section, which e.g. enable a force-locked and/or a form-locked fastening of the sealing element in the respective sealing element receiving section. The respective fastening elements can e.g. be screw or latching/snap elements.

In addition to the powder chamber table assembly, the invention furthermore relates to a powder module for an apparatus for additive manufacturing of three-dimensional objects. The powder module is characterized in that it comprises a powder chamber table assembly as described. The powder module typically comprises a powder chamber limiting a powder room. The powder chamber table assembly is arranged in the powder room completing it at the bottom, and is movably supported relative to the powder chamber by a motor operated drive or actuator device associated with the powder module. The powder module is especially a construction module.

In addition, the invention relates to an apparatus for additive manufacturing of three-dimensional objects. The apparatus is characterized in that it comprises at least one power module as described. The apparatus can especially be an apparatus for performing selective laser melting processes, i.e. an SLM apparatus, or an apparatus for performing selective laser sintering processes, i.e. an SLS apparatus.

Both in connection with the powder module and in connection with the apparatus, the explanations in connection with the powder chamber table assembly apply analogously.

The invention is explained in more detail by means of exemplary embodiments in the figures of the drawings. In which:

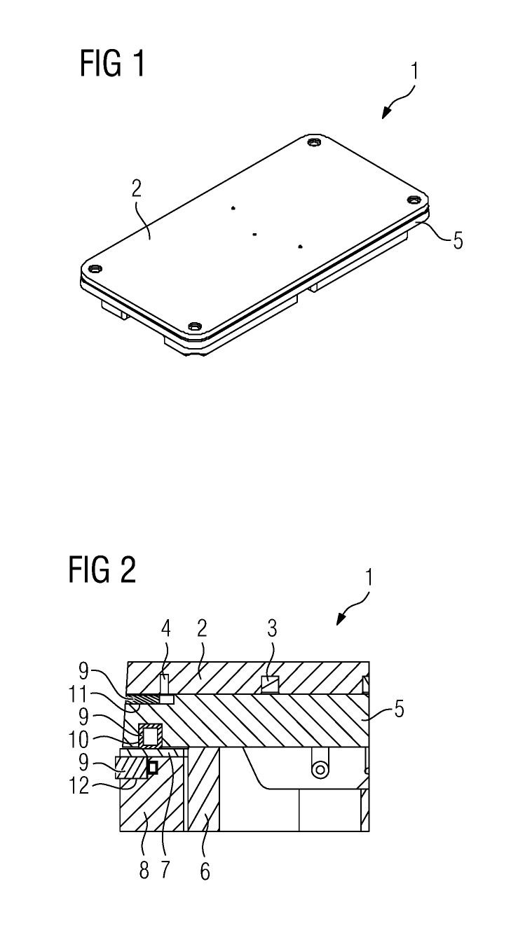

FIGS. 1, 2 each show a schematic diagram of a powder chamber table assembly according to an exemplary embodiment.

FIGS. 1, 2 each show a schematic diagram of a powder chamber table assembly 1 according to an exemplary embodiment. The powder chamber table assembly 1 is represented in a perspective full view in FIG. 1 and in a cross-sectional partial view in FIG. 2.

The powder chamber table assembly 1 represents a functional component of a powder module (not shown), i.e. especially a construction module, in which the actual additive construction of three-dimensional objects is done when performing additive manufacturing processes. A respective powder module in turn represents a functional component of an apparatus (not shown) for additive manufacturing of three-dimensional objects. The apparatus can be an apparatus for performing selective laser melting processes, i.e. an SLM apparatus, or an apparatus for performing selective laser sintering processes, i.e. an SLS apparatus.

The structural design of the powder chamber table assembly 1 comprises several components or component groups, which hereinafter are described in more detail especially by FIG. 2.

At first, the powder chamber table assembly 1 comprises a plate-shaped heater 2. The heater 2 is formed of a material that is thermally well-conductive, i.e. for example of a metal, especially aluminum. The heater 2 or the top face thereof forms the exposed top face of the powder chamber table assembly 1. The additive construction of three-dimensional objects is typically done on the top face of the heater 2. The heater 2 comprises several heating elements 3 arranged or formed in receiving rooms (not denoted in more detail) of the heater. The heating elements 3 can e.g. be (electric) heating coils. Further, the heater 2 comprises a recess 4 in a side edge portion, which avoids or inhibits the transfer of thermal energy from the heater in components of the powder chamber table assembly 1 arranged below said heater.

Below the heater 2 a first plate-shaped insulating body 5 is arranged oriented horizontally. The first insulating body 5 is formed of a thermally insulating material, i.e. for example of a fiber composite material. By reference number 6, another insulating body is denoted, formed analogously, but oriented vertically, which is arranged or formed below the first insulating body 5.

In the area of a side edge portion a plate-shaped supporting body 7 is arranged below the first insulating body 5. The supporting body 7 is typically formed of metal, especially aluminum.

Below the supporting body 7 a carrying body 8 is arranged forming a part of a supporting or carrying structure (not denoted in more detail). The carrying body 8 is formed of metal, especially aluminum.

The aforementioned components of the powder chamber table assembly 1 are typically fastened to each other by screw connections (not denoted in more detail), the components, as can be seen in FIG. 1, are provided for with respective bores (not denoted in more detail).

Especially the aforementioned components heater 2, first insulating body 5 and supporting body 7 are components of the powder chamber table assembly 1, which are to be sealed to each other, especially in terms of the intrusion of powdered construction material.

By means of FIG. 2 the sealing of the first insulating body 5 to the supporting body 7 arranged below that is explained. To seal the components, the powder chamber table assembly 1 comprises a sealing element 9. Apparently, the sealing element 9 is arranged between the components, i.e. between the first insulating body 5 and the supporting body 7. The sealing element 9 seals the first insulating body 5 to the supporting body 7 (or vice versa) such that an intrusion of powdered construction material into the sealing section defined hereby is not possible. The sealing element 9 is arranged or formed in a groove-shaped sealing element receiving section 10 formed in a surface section of the first insulating body 5 facing the supporting body 7. Apparently, the sealing element 9 has a U-shaped cross-section geometry such that it fills the sealing element receiving section 10 partially. Of course, it is also imaginable that a respective sealing element 9 fills the sealing element receiving section completely.

The sealing element 9 is formed of a one-component or multicomponent high temperature resistant silicone material or silicone. By forming the sealing element 9 of a respective silicone material the sealing element 9 is high temperature resistant. The sealing properties of the sealing element 9 are thus also given at comparatively high temperatures, as may affect the sealing element 9 in the design shown in the present exemplary embodiment when forming the powder chamber table assembly 1 for a heatable construction module. Depending on the precise chemo-physical structure, the silicone material and thus the sealing element 9 can have a temperature resistance of up to a temperature range of at least 200° C., especially above 250° C., possibly at least temporarily above 300° C.

However, the silicone material forming the sealing element 9 is not only characterized by its specific temperature resistance, but also by its elasticity or flexibility, especially at appropriately high temperatures. The elasticity or flexibility of the silicone material also given at appropriately high temperatures ensures that the sealing element 9, e.g. due to a thermal-related embrittlement, is not damaged, e.g. related to breaking or tearing, which would affect its sealing properties.

The silicone material can, for example, be acetate silicone or silicone rubber (VMQ) or silicone elastomer. Acetate silicones or silicone rubbers or silicone elastomers typically have a high thermal stability and thus a high temperature resistance. Furthermore, acetate silicones have excellent adhesive properties, which guarantee a simple and non-detachable assembly of the sealing element 9 in the sealing element receiving section 10.

Furthermore, the silicone material can be at least partially cross-linked. The cross-linking of the silicone realized e.g. by means of highly (energetic) radiation typically further improves the thermal stability and thus the temperature resistance thereof.

By means of FIG. 2 it can be seen that the powder chamber table assembly 1 comprises further sealing elements 9:

A second sealing element 9, which in principle can be formed at least in terms of the material forming said element analogous to the first sealing element 9 described before, arranged in the sealing element receiving section 10 of the insulating body, is arranged in a joint-type sealing element receiving section 11 that is open on one side, extending between the heater 2 and the first insulating body 5. The sealing element receiving section 11 can also be referred to or considered as expansion joint.

A third sealing element 9 which in principle can be formed at least in terms of the material forming said element analogous to the first sealing element 9, arranged in the sealing element receiving section 10 of the insulating body, is arranged in a sealing element receiving section 12 that is open on one side, extending between the supporting body 7 and the carrying body 8. However, the third sealing element 9 does not need to be formed of a high temperature resistant silicone material; the third sealing element 9 can also be a felt seal.

As a general rule, a respective sealing element 9 with any, possibly varying, cross-section geometries or profiles can be provided. The cross-section geometry of a respective sealing element 9 is selected especially depending on the geometric structural design of the sealing element receiving section 10, 11, 12 receiving the sealing element.

If required, separate fastening elements (not shown) can be provided for fastening a sealing element 9 in a respective sealing element receiving section 10, 11, 12, which e.g. enable a force-locked and/or a form-locked fastening of the sealing element 9 in the respective sealing element receiving section 10, 11, 12. The respective fastening elements can e.g. be screw or latching/snap elements.

1. A powder chamber table assembly (1) for a powder module of an apparatus for additive manufacturing of three-dimensional objects, comprising
at least two components or component groups to be sealed to each other especially in terms of the intrusion of powdered construction material,
wherein the at least two components or component groups are sealed to each other by at least one sealing element (9), characterized in that the sealing element (9) is formed of or comprises a high temperature resistant silicone material.

2. The powder chamber table assembly according to claim 1, characterized in that the high temperature silicone material is an acetate silicone or a silicone rubber.

3. The powder chamber table assembly according to claim 1, characterized in that the high temperature resistant silicone material is at least partially cross-linked.

4. The powder chamber table assembly according to claim 1, characterized in that the high temperature resistant silicone material has a temperature resistance up to a temperature range of at least 200° C., especially above 250° C.

5. The powder chamber table assembly according to claim 1, characterized in that it comprises an, especially plate-type, insulating body (5) and an, especially plate-type, supporting body (7) arranged or formed below the insulating body (5), wherein the sealing element (9) is arranged or formed at least partially between the insulating body (5) and the supporting body (7).

6. The powder chamber table assembly according to claim 5, characterized in that the sealing element (9) is arranged or formed in a groove-shaped sealing element receiving section (10) formed in an insulating body (5), especially in a surface section facing the supporting body (7).

7. The powder chamber table assembly according to claim 6, characterized in that the sealing element (9) is arranged or formed in the sealing element receiving section (10) at least partially filling in the groove-shaped sealing element receiving section (10).

8. The powder chamber table assembly according to claim 1, characterized in that it comprises an, especially plate-type, heater (2) forming an exposed top face of the powder chamber table assembly (1), and the or an, especially plate-type insulating body (5) arranged or formed below said heater, wherein the sealing element (9) is arranged or formed at least partially between the heater (2) and the insulating body (5).

9. The powder chamber table assembly according to claim 8, characterized in that the sealing element (9) is arranged or formed in a joint-shaped sealing element receiving section (11) open on one side and extending between the heater (2) and the insulating body (5).

10. The powder chamber table assembly according to claim 9, characterized in that the sealing element (9) is arranged or formed in the joint room at least partially filling in the groove-shaped sealing element receiving section (11).

11. A powder module for an apparatus for additive manufacturing of three-dimensional objects, comprising a powder chamber table assembly (1) according to claim 1.

12. An apparatus for additive manufacturing of three-dimensional objects, comprising a powder module according to claim 11.
